(19) United States
(12) Patent Application Publication
(10) Pub. No.: US 2019/0109309 A1
(43) Pub. Date: Apr. 11, 2019

(54) POROUS FILM, SEPARATOR INCLUDING POROUS FILM, ELECTROCHEMICAL DEVICE INCLUDING POROUS FILM, AND METHOD OF PREPARING POROUS FILM

(71) Applicant: Samsung Electronics Co., Ltd., Suwon-si (KR)

(72) Inventors: Nagjong Kim, Suwon-si (KR); Kitae Park, Suwon-si (KR); Jinkyu Kang, Hwaseong-si (KR); Jinhwan Park, Suwon-si (KR); Sunghaeng Lee, Seoul (KR)

(21) Appl. No.: 16/156,851

(22) Filed: Oct. 10, 2018

(30) Foreign Application Priority Data
Oct. 10, 2017 (KR) 10-2017-0129117

(51) Int. Cl. H01M 2/16; H01M 10/052; H01M 2/14; H01G 11/52; H01G 11/84

(52) U.S. Cl. CPC H01M 2/1626; H01M 10/052; H01G 11/84; H01G 11/52; H01M 2/145

(57) ABSTRACT

Provided are a porous film including cellulose nanofibers and having a transmittance of 70 percent (%) or higher and a haze of 50% or lower, as measured according to ASTM D1003 using a CIE1931 color space (Illuminant C and a 2° observer) at a thickness of 16 micrometers (μm); a separator including the porous film; an electrochemical device including the porous film; and a method of preparing the porous film.

### CROSS-REFERENCE TO RELATED APPLICATION

This application claims the benefit of Korean Patent Application No. 10-2017-0129117, filed on Oct. 10, 2017, in the Korean Intellectual Property Office, the entire disclosure of which is hereby incorporated by reference.

### BACKGROUND

### 1. Field

The present disclosure relates to a porous film, a separator including the porous film, an electrochemical device including the porous film, and a method of preparing the porous film.

### 2. Description of the Related Art

Electrochemical cells such as lithium secondary batteries include a separator that prevents a short circuit by separating a positive electrode and a negative electrode from each other. The separator needs to be tolerant to an electrolyte solution and have low internal resistance. Recently, demand has increased for electrochemical cells having high thermal resistance for use in vehicles. In presently available cells, a polyolefin-based porous film including polyethylene or polypropylene has been used as a separator in a lithium secondary battery. However, in the case of a battery for a vehicle, high thermal resistance at a temperature of about 150° C. or higher is required, and thus a polyolefin-based separator, having relatively poor thermal resistance, may not be useful.

Porous films including cellulose have high thermal resistance, and thus are suitable for use as separators. A porous film including cellulose may have pores introduced by a pore forming agent. In the related art, a porous film is obtained using a conventional pore forming agent; however, due to excessive shrinkage in a drying process, the porous film has poor uniformity. For example, upon charging and discharging of a lithium battery including a separator that includes such a porous film having poor uniformity, a portion of the porous film having defects may readily fail, thus deteriorating charge/discharge characteristics of the lithium battery. Therefore, there is a need for a porous film that has improved uniformity.

### SUMMARY

Provided is a porous film having improved uniformity and charge/discharge characteristics. According to an aspect of the disclosure, a porous film may include cellulose nanofibers, wherein the porous film has a transmittance of 70 percent (%) or higher and a haze of 50% or lower, as measured according to ASTM D1003 using a CIE1931 color space (Illuminant C and a 2° observer) at a thickness of 16 micrometers ( μm).

Provided is a separator including the porous film.

Provided is an electrochemical device including the separator.

Also provided is a method of preparing the porous film. According to an aspect of the disclosure, a method of preparing a porous film may include coating a composition on a substrate, the composition including cellulose nanofibers and a hydrophilic pore forming agent that is solid at room temperature; drying the composition to form a sheet on the substrate; and separating the sheet from the substrate to obtain a porous film including the sheet.

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1A is an image showing the appearance of a porous film prepared in Example 2;

FIG. 1B is an image showing the appearance of a porous film prepared in Comparative Example 2;

FIG. 2 is a graph of cycle number versus discharge capacity retention [percent, %], illustrating capacity retention of lithium batteries prepared in Example 3 and Comparative Examples 4 to 6; and

FIG. 3 is a schematic view of a lithium battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

As the present inventive concept allows for various changes and numerous embodiments, particular embodiments will be illustrated in the drawings and described in detail in the written description. However, this is not intended to limit the present inventive concept to particular modes of practice, and it is to be appreciated that all changes, equivalents, and substitutes that do not depart from the spirit and technical scope of the present inventive concept are encompassed in the present inventive concept.

The terms used in the present specification are merely used to describe particular embodiments, and are not intended to limit the present inventive concept. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, ingredients, materials, or combinations thereof disclosed in the specification, and are not intended to preclude the possibility that one or more other features, numbers, steps, actions, components, parts, ingredients, materials, or combinations thereof may exist or may be added.

In the drawings, the thicknesses of layers and regions are exaggerated or reduced for clarity. Like reference numerals in the drawings and specification denote like elements. In the present specification, it will be understood that when an element, e.g., a layer, a film, a region, or a substrate, is referred to as being “on” or “above” another element, it can be directly on the other element or intervening layers may also be present. While such terms as “first,” “second,” etc., may be used to describe various components, such components must not be limited to the above terms. The above terms are used only to distinguish one component from another.

Hereinafter, a porous film, a separator including the porous film, an electrochemical device including the porous film, and a method of preparing the porous film will be described in further detail according to one or more embodiments..

According to one or more embodiments, a porous film may include cellulose nanofibers and have a light transmittance of 70 percent (%) or higher and a haze of 50% or lower, as measured according to ASTM D1003 using a CIE1931 (Illuminant C and a 2° observer) color space at a thickness of 16 micrometers (μm). The high transmittance and low haze indicates that the porous film may have improved uniformity in the structure (e.g., pore structure). Thus, upon a long-term charging and discharging a lithium battery that includes the porous film as a separator, failure of the separator due to localized defects of the porous film may be suppressed; thus, lifespan characteristics of the lithium battery may improve. In certain embodiments, the porous film may have a transmittance of 55% or higher, 60% or higher, 65% or higher, 70% or higher, 75% or higher, or 80% or higher, measured according to ASTM D1003 using a color space CIE1931 (Illuminant C and a 2° observer) at a thickness of 16 μm. The porous film may have a haze of 90% or lower, 70% or lower, 60% or lower, 55% or lower, 50% or lower, 45% or lower, 40% or lower, 35% or lower, 30% or lower, or 25% or lower, measured according to ASTM D1003 using a color space CIE1931 (Illuminant C and a 2° observer) at a thickness of 16 μm.

In the porous film according to certain embodiments, a content of tangled or aggregated nanofibers having a diameter of 200 nanometers (nm) or greater may be 20% by weight or lower, 15 wt % or lower, 10 wt % or lower, 5 wt % or lower, or 1 wt % or lower, based on a total weight of the cellulose nanofibers. When a content of tangled or aggregated nanofibers having a diameter of 200 nm or greater is greater than 20 wt %, based on a total weight of the cellulose nanofibers, a content of the cellulose fibers having a thickness of 200 nm or greater, for example, a thickness of 1 μm or greater, may increase in the porous film. Thus, the number of points of contact via hydrogen bonds between the cellulose fibers may decrease, which may result in lowered strength of the porous film.

The porous film may, according to certain embodiments, further include a monomeric organic compound that is solid at a temperature of 30⊐ or less. The monomeric organic compound has a melting point of 20° C. or more. The monomeric organic compound that is solid at a temperature of 30□ or less may remain in the porous film as a pore forming agent during a preparation process of the porous film. A content of the monomeric organic compound, as measured by using gas chromatography-mass spectrometry (GC-MS), performance liquid chromatography (HPLC) or weight conversion, may be higher than about 0 wt % to about 10 wt % or lower, higher than about 0 wt % to about 8 wt % or lower, higher than about 0 wt % to about 6 wt % or lower, higher than about 0 wt % to about 4 wt % or lower, higher than about 0 wt % to about 2 wt % or lower, higher than about 0 wt % to about 1.5 wt % or lower, higher than about 0 wt % to about 1.3 wt % or lower, higher than about 0 wt % to about 1.2 wt % or lower, or higher than about 0 wt % to about 1 wt % or lower, based on a total weight of the porous film. In a case where a content of the monomeric organic compound remaining in the porous film, i.e., residual monomeric organic compound, is greater than about 10 wt %, the porosity and gas permeability of the film may be lowered.

The porous film may have a pore diameter of 0.8 μm or less, 0.7 μm or less, 0.6 μm or less, 0.5 μm or less, 0.4 μm or less, 0.3 μm or less, 0.2 μm or less, 0.15 μm or less, 0.12 μm or less, 0.11 μm or less, 0.1 μm or less, 0.09 μm or less, 0.08 μm or less, or 0.07 μm or less, wherein the pore diameter is a maximal peak diameter in a pore size distribution measured by a mercury penetration method. In a case where a pore diameter of the porous film is excessively great, lithium may be easily precipitated within the pore. Thus, in a case where the porous film having an excessively great pore diameter is used as a separator for a lithium battery, lithium blocking characteristics of the separator may be deteriorated, and thus lithium dendrite formation may occur, which may cause a short circuit. The porous film may have a pore diameter of 0.01 μm or greater, 0.02 μm or greater, or 0.03 μm or greater, wherein the pore diameter is a maximal peak diameter in a pore size distribution measured by a mercury penetration method. In a case where a pore diameter of the porous film is excessively small, migration of lithium ions through the porous film may be hindered. Thus, in a case where the porous film having an excessively small pore diameter is used as a separator for a lithium battery, internal resistance of the lithium battery may increase, and thus cycle characteristics of the lithium battery may be deteriorated.

The porous film may have a bimodal pore size distribution having two peak diameters in a pore size distribution measured by a mercury penetration method. For example, the porous film may have a first peak diameter, i.e., a small-diameter pore and a second peak diameter, i.e., a large-diameter pore. As the porous film includes a large-diameter pore as well as a small-diameter pore, the porosity and gas permeability of the porous film may further improve. A pore diameter of a small-diameter pore may be in a range of about 0.001 μm to about 0.1 μm, about 0.01 μm to about 0.1 μm, about 0.02 μm to about 0.1 μm, about 0.03 μm to about 0.1 μm, about 0.04 μm to about 0.1 μm, or about 0.05 μm to about 0.1 μm. In a case where a pore diameter of a small-diameter pore of the porous film is excessively small, the physical properties of the porous film may be substantially the same as that of the porous film having one peak diameter in a pore size distribution. In a case where a pore diameter of a small-diameter pore of the porous film is excessively large, a small-diameter pore may not be distinguishable from the large-diameter pore. A pore diameter of a large-diameter pore may be in a range of about 0.1 μm to about 1 μm, about 0.1 μm to about 0.8 μm, about 0.1 μm to about 0.7 μm, about 0.1 μm to about 0.6 μm, about 0.1 μm to about 0.5 μm, or about 0.1 μm to about 0.4 μm. In a case where a pore diameter of a large-diameter pore of the porous film is excessively small, a large-diameter pore may not be distinguishable from a small-diameter pore. In a case where a pore diameter of a large-diameter pore of the porous film is excessively large, the porosity and gas permeability of the porous film may excessively increase, and thus, when this porous film is used as a separator for a lithium battery, it is difficult to suppress formation and growth of lithium dendrite, which may be more likely to result in a short circuit in the lithium battery.

The gas permeability of the porous film may be a Gurley value in a range of about 50 sec/100 cc to about 800 sec/100 cc, about 100 sec/100 cc to about 750 sec/100 cc, about 150 sec/100 cc to about 700 sec/100 cc, about 200 sec/100 cc to about 650 sec/100 cc, about 250 sec/100 cc to about 600 sec/100 cc, about 300 sec/100 cc to about 600 sec/100 cc, about 350 sec/100 cc to about 600 sec/100 cc, about 350 sec/100 cc to about 550 sec/100 cc, or about 350 sec/100 cc to about 500 sec/100 cc. The Gurley value may be measured by a method according to Japanese Industrial Standards (JIS) P8117. In a case where the Gurley value is too low, lithium may be easily precipitated within a pore in the porous film. Thus, in a case where the porous film having an excessively low Gurley value is used as a separator for a lithium battery, lithium blocking characteristics of the separator may be deteriorated, and thus lithium dendrite may be more likely to cause a short circuit. In a case where the Gurley value is excessively large, migration of lithium ions through the porous film may be hindered. Thus, in a case where the porous film having an excessively large Gurley value is used as a separator for a lithium battery, internal resistance of the lithium battery may increase, and thus cycle characteristics of the lithium battery may be deteriorated. In some embodiments, the porous film may have a uniform Gurley value throughout the entire region of the porous film. As the porous film has a uniform gas permeability, in a lithium battery including the porous film as a separator, current density may be uniformly distributed in an electrolyte, and thus, occurrence of a side reaction may be suppressed. For example, the side reaction may be eduction of crystal at an interface between an electrode and the electrolyte.

The porous film may have a film resistance of 1.6 ohm (Ω) or less, 1.4 Ω or less, 1.2 Ω or less, 1.0 Ω or less, 0.8 Ω or less, 0.6 Ω or less, or 0.4 Ω or less, wherein the film resistance is measured using an alternating current of a frequency of 20 kilohertz (kHz), wherein a circular sample of the porous film, i.e., a circular separator, with a diameter of 19 millimeters (mm, 19 ϕ) and impregnated with an electrolyte solution of ethylene carbonate (EC):ethyl methyl carbonate (EMC):dimethyl carbonate (DMC) at a volume ratio of 2:2:6 and including 1 molar (M) LiPF₆. In a case where the resistance of the porous film is excessively large, internal resistance of the lithium battery may increase. Thus, in a case where the porous film having an excessively large resistance is used as a separator for a lithium battery, charge/discharge characteristics of the lithium battery may be deteriorated.

A porosity of the porous film may be in a range of about 10% to about 90%, about 15% to about 85%, about 20% to about 80%, about 25% to about 80%, about 30% to about 80%, about 35% to about 80%, about 35% to about 75%, or about 40% to about 75%. It may be possible to operate an electrochemical device even in a case where a porosity is less than 10%; however, the low porosity may result in a great internal resistance and a low output, thereby deteriorating performances of the electrochemical device. In a case where a porosity is greater than 90%, an internal resistance may be too low, which may result in improved output characteristics of an electrochemical device, e.g., improved cycle characteristics of a lithium battery; however, short circuit may be more likely to occur due to lithium dendrite, which may consequently result in deteriorated stability. A porosity of the porous film may be measured by using a liquid or gas absorption method according to ASTM D-2873 (Standard Test Method for Interior Porosity of Poly(Vinyl Chloride) (PBC) Resins by Mercury Intrusion Porosimetry).

The cellulose nanofibers included in the porous film may be carboxyl-group-containing cellulose nanofibers. For example, the carboxyl group contained in the cellulose nanofibers of the porous film may be a carboxyl group bound to a carbon that is part of a pyranose ring. The carboxyl group may be represented by Formula 1 or Formula 2:

—R₁—O‘3R₂—COOM Formula 1

—O—R₂—COOM Formula 2

In Formulae 1 and 2, R₁ and R₂ may each independently be a substituted or unsubstituted C₁-C₁₀ alkylene group, and M may be hydrogen or an alkali metal. For example, the alkali metal may be lithium, sodium, or potassium. For example, R₁ and R₂ may each independently be a methylene group. For example, the carboxyl group, which is contained in the carboxyl-group-containing cellulose nanofibers, bound to a carbon that is part of a pyranose ring may be —CH₂OCH₂COONa or —OCH₂COONa. The pyranose ring may be, for example, glucopyranose.

In this regard, the carboxyl group represented by Formula 1 or Formula 2 in the carboxyl-group-containing cellulose nanofibers has a particular structure that is different from a COOM structure of a conventional carboxyl group bound to a carbon that is part of a pyranose ring in oxidized cellulose nanofibers obtained by a chemical oxidation reaction.

The carboxyl-group-containing cellulose nanofibers may be included in the porous film at an amount in a range of about 30 wt % to about 100 wt %, about 40 wt % to about 100 wt %, about 50 wt % to about 100 wt %, about 60 wt % to about 100 wt %, about 70 wt % to about 100 wt %, about 80 wt % to about 100 wt %, about 90 wt % to about 100 wt %, about 95 wt % to about 100 wt %, about 30 wt % to about 95 wt %, about 40 wt % to about 92 wt %, about 50 wt % to about 95 wt %, about 60 wt % to about 95 wt %, about 70 wt % to about 95 wt %, about 80 wt % to about 95 wt %, about 90 wt % to about 95 wt %, about 95 wt % to about 97.5 wt %, about 30 wt % to about 80 wt %, about 30 wt % to about 70 wt %, about 30 wt % to about 60 wt %, about 30 wt % to about 50 wt %, about 40 wt % to about 80 wt %, about 40 wt % to about 70 wt %, about 40 wt % to about 60 wt %, about 50 wt % to about 80 wt %, or about 50 wt % to about 90 wt %, based on a total weight of the porous film.

An amount of the carboxyl group of the carboxyl-group-containing cellulose nanofibers in the porous film may be 0.02 millimole per gram (mmol/g) or greater, 0.06 mmol/g or greater, 0.10 mmol/g or greater, 0.15 mmol/g or greater, or 0.20 mmol/g or greater. For example, an amount of the carboxyl group of the carboxyl-group-containing cellulose nanofibers in the porous film may be in a range of about 0.02 mmol/g to about 10 mmol/g, about 0.02 mmol/g to about 5 mmol/g, about 0.02 mmol/g to about 3 mmol/g, about 0.02 mmol/g to about 2 mmol/g, or about 0.02 mmol/g to about 1 mmol/g. When the porous film includes the carboxyl-group-containing cellulose nanofibers having an amount of a carboxyl group within any of these ranges, the porous film may have improved tensile strength and tensile modulus. A method of measuring an amount of a carboxyl group in the cellulose nanofibers may be understood by referring to Evaluation Example 2.

A tensile strength of the porous film may be 60 megapascals (MPa) or greater, 65 MPa or greater, 70 MPa or greater, 75 MPa or greater, 80 MPa or greater, 85 MPa or greater, or 90 MPa or greater. For example, a tensile strength of the porous film may be in a range of about 60 MPa to about 400 MPa, about 65 MPa to about 400 MPa, about 70 MPa to about 400 MPa, about 75 MPa to about 400 MPa, about 80 MPa to about 400 MPa, about 85 MPa to about 300 MPa, or about 90 MPa to about 200 MPa. When the porous film, which has a tensile strength within any of these ranges, is used, the tensile strength required for manufacturing a winding-type battery may be obtained, and puncture strength may also be improved. When such a porous film is used as a separator, separator durability during a charge/discharge process of a lithium battery may increase, and capacity of the lithium battery may increase as separator thickness decreases. When a tensile strength of the porous film is less than 60 MPa, durability of the separator may deteriorate, yield may decrease according to damage that has occurred during preparation of a battery, a winding-type battery may not be manufactured, durability of the separator may be low due to a puncture strength being weak, and a battery capacity may deteriorate as a separator thickness for securing a minimum tension increases. The tensile strength is measured in accordance with ASTM D-638 (Standard Test Method for Tensile Properties of Plastics).

An average diameter of the carboxyl-group-containing cellulose nanofibers in the porous film may be 100 nm or less, 80 nm or less, 60 nm or less, 50 nm or less, 45 nm or less, 40 nm or less, 35 nm or less, 30 nm or less, or 25 nm or less. For example, an average diameter of the cellulose nanofibers in the porous film may be in a range of about 1 nm to about 100 nm, about 1 nm to about 80 nm, about 1 nm to about 60 nm, about 1 nm to about 50 nm, about 1 nm to about 45 nm, or about 5 nm to about 45 nm. When the porous film includes the cellulose nanofibers having an average diameter within any of these ranges, a tensile strength of the porous film may improve. When an average diameter of the cellulose nanofibers is greater than 100 nm, dispersibility of the cellulose nanofibers may deteriorate, and thus tensile strength of the porous film prepared using the cellulose nanofibers may deteriorate. A method of measuring an average diameter of the cellulose nanofibers may be understood by referring to Evaluation Example 3.

A full width at half maximum (FWHM) of at least one diameter peak in a diameter distribution of the cellulose nanofibers in the porous film may be 50 nm or less, 45 nm or less, 40 nm or less, 35 nm or less, 30 nm or less, 25 nm or less, 20 nm or less, 15 nm or less, or 10 nm or less. For example, a FWHM of a diameter peak in a diameter distribution of the cellulose nanofibers may be in a range of about 1 nm to about 45 nm, about 5 nm to about 45 nm, or about 10 nm to about 45 nm. In a case where the cellulose nanofibers have such a narrow FWHM, homogeneity of the porous film prepared by using the cellulose nanofibers improves, and tensile strength may increase as the number of contact points between fibers increases. In a case where a FWHM of the cellulose nanofibers increases excessively, an amount of the cellulose nanofibers having a large diameter increases, and thus homogeneity of the porous film prepared by using the cellulose nanofibers may deteriorate and the number of contact points between fibers may decrease, which may result in deterioration of the tensile strength.

The cellulose nanofibers in the porous film may be microbial cellulose nanofibers (or bacterial cellulose nanofibers). That is, the microbial cellulose nanofibers result from fermentation of a culture solution including a bacterium and may be directly obtained from the culture solution including a bacterium. In some embodiments, the carboxyl-group-containing cellulose nanofibers in the porous film may be carboxyl-group-containing microbial cellulose nanofibers (or carboxyl-group-containing bacterial cellulose nanofibers). That is, the carboxyl-group-containing microbial cellulose nanofibers result from fermentation of a culture solution including a bacterium and may be directly obtained from the culture solution including a bacterium. Therefore, the carboxyl-group-containing microbial cellulose nanofibers is different from a simple mixture of conventional microbial cellulose nanofibers and a carboxyl-group-containing compound. In addition, the microbial cellulose nanofibers may be different from wood cellulose nanofibers obtained by decomposition of wood material. The carboxyl-group-containing microbial cellulose included in the porous film may have an absorption peak that corresponds to a carboxyl group about 1,572 cm⁻¹ in an infrared (IR) spectrum. Microbial cellulose not including a carboxyl group does not have the absorption peak.

For example, the microbial cellulose may be may be obtained by using a bacterium derived from the genus Enterobacter, Gluconacetobacter, Komagataeibacter, Acetobacter, Achromobacter, Agrobacterium, Alcaligenes, Azotobacter, Pseudomonas, Rhizobium, Sarcina, Klebsiella, or Escherichia, but embodiments are not limited thereto. Any suitable bacterium available in the art capable of producing the microbial cellulose may be used. For example, a bacterium of the genus Actetobacter may be Actetobacter pasteurianus. For example, a bacterium of the genus Agrobacterium may be Agrobacterium tumefaciens. For example, a bacterium of the genus Rhizobium may be Rhizobium leguminosarum. For example, a bacterium of the genus Sarcina may be Sarcina ventriculi. For example, a bacterium of the genus Gluconacetobacter may be Gluconacetobacter xylinum. For example, a bacterium of the genus Klebsiella may be Klebsiella pneumoniae. A bacterium of the genus Escherichia may be Escherichia coli.

In certain embodiments, the porous film may further include a combination of different types of cellulose nanofibers, other than the microbial cellulose nanofibers. For example, the porous film may further comprise wood cellulose nanofibers, but embodiments are not limited thereto. Any suitable cellulose nanofibers capable of improving tensile strength of a separator available in the art may be used.

A tensile modulus of the porous film may be 1,000 MPa or greater, 1,200 MPa or greater, or 1,400 MPa or greater. In certain embodiments, a tensile modulus of the porous film may be 1,500 MPa or greater, 1,700 MPa or greater, 2,000 MPa or greater, or 2,200 MPa or greater. For example, a tensile modulus of the porous film may be in a range of about 1,000 MPa to about 3,000 MPa. When the porous film having a tensile modulus within any of these ranges is included, deterioration of the separator during a charge/discharge process may be effectively prevented. When a tensile modulus of the porous film is less than 1,000 MPa, durability of the separator may deteriorate. The tensile modulus is measured in accordance with ASTM D-638 (Standard Test Method for Tensile Properties of Plastics).

In some embodiments, the porous film has a low contact angle with respect to a polar solvent, such as water, and thus provides enhanced wettability with respect to an electrolyte in a polar solvent. A contact angle of the porous film with water at 20␣ may be 60° or less, 50° or less, 40° or less, 30° or less, or 20° or less. When a contact angle of the porous film with water at 20□ is excessively large, the electrolyte may not be impregnated into the porous film. When the separator including the porous film provides improved wettability with respect to the electrolyte, the electrolyte may be homogeneously impregnated into an interface between the separator and an electrode. Thus an electrode reaction may be homogenously performed between the separator and the electrode, which may result in prevention of formation of lithium dendrites (for example, caused by excessive localized current) and improvement of lifespan characteristics of an electrochemical cell.

The porous film has excellent thermal stability at a high temperature (for example, temperatures of 150□ or higher), thus improving the thermal resistance of an electrochemical cell including the porous film as a separator. In certain embodiments, the thermal shrinkage of the porous film after incubating the porous film at 150□ for 30 minutes may be 5% or lower, 4.5% or lower, 4% or lower, 3.5% or lower, 3% or lower, 2.5% or lower, 2% or lower, 1.5% or lower, or 1° A or lower.

The porous film may be obtained from a composition including cellulose nanofibers and a hydrophilic pore forming agent that is solid at room temperature. In some embodiments, the porous film may be obtained by using a method of preparing a porous film. The method may include coating a composition on a substrate; drying the composition to form a sheet on the substrate; and separating the sheet from the substrate to obtain a porous film, wherein the composition may include cellulose nanofibers and a hydrophilic pore forming agent that is solid at room temperature.

By adjusting solubility of the hydrophilic pore forming agent with respect to water, a pore size of the porous film may be controlled. For example, a solubility of the hydrophilic pore forming agent in the composition with respect to water may be 5 wt % or higher, 6 wt % or higher, 8 wt % or higher, 10 wt % or higher, 15 wt % or higher, 20 wt % or higher, 25 wt % or higher, 30 wt % or higher, or 35 wt % or higher. When the solubility of the hydrophilic pore forming agent with respect to water is too low, it may be difficult to control the porosity only with the hydrophilic pore forming agent.

By adjusting an added amount of the hydrophilic pore forming agent with respect to water, a porosity of the porous film may be controlled. For example, an amount of the pore forming agent may be in a range of about 10 parts to about 1,000 parts by weight, about 20 parts to about 900 parts by weight, about 30 parts to about 800 parts by weight, about 40 parts to about 700 parts by weight, about 50 parts to about 600 parts by weight, about 60 parts to about 500 parts by weight, about 70 parts to about 400 parts by weight, based on 100 parts by weight of the cellulose nanofibers.

The hydrophilic pore forming agent may be a monomeric organic compound having a molecular weight of 500 Daltons or lower, 450 Daltons or lower, 400 Daltons or lower, 350 Daltons or lower, 300 Daltons or lower, 250 Daltons or lower, 200 Daltons or lower, 150 Daltons or lower, or 100 Daltons or lower. When a molecular weight of the hydrophilic pore forming agent is excessively large, or when the hydrophilic pore forming agent is polymer such as polyethylene glycol, it may be difficult to completely remove the hydrophilic pore forming agent from a sheet by washing with an organic solvent. Consequently, the amount of the pore forming agent remaining in the porous film may increase, which may result in occurrence of a side reaction in a case where the porous film is used as a separator.

In some embodiments, the pore forming agent is a solid at room temperature, i.e., 20° C. (at standard atmospheric pressure, i.e., 1 ATM). Thus, the melting point (under standard pressure, 1ATM) of the hydrophilic pore forming agent in the composition may be, for instance, 20⊐ or higher, 25□ or higher, 30□ or higher, or 35□ or higher. In a case where a melting point of the hydrophilic pore forming agent is lower than a temperature of 20□, the hydrophilic pore forming agent may not be solid at room temperature. A boiling point of the hydrophilic pore forming agent in the composition may be a temperature of 130⊏ or higher, 140□ or higher, 150□ or higher, 160□ or higher, 170□or higher, 180□or higher, 190□or higher, 200□or higher, 210□or higher, 220␣ or higher, 230␣ or higher, or 240␣ or higher. In a case where a boiling point of the hydrophilic pore forming agent is lower than a temperature of 130□, the pore forming agent may evaporate with water, i.e., solvent, thus failing to function properly. The hydrophilic pore forming agent in the composition may include at least one selected from ethylene carbonate, vinylene carbonate, propane sulfone, ethylene sulfate, dimethyl sulfone, ethyl methyl sulfone, dipropyl sulfone, dibutyl sulfone, trimethylene sulfone, tetramethylene sulfone, di(methoxyethyl)sulfone (CH₃OCH₂CH₂)₂SO₂), and ethyl cyclopentyl sulfone (C₂H₅SO₂C₅H₉).

In certain embodiments, the porous film may further include at least one selected from a cross-linking agent and a binder. A porous film further including a cross-linking agent and/or a binder may have further improved tensile strength.

The cross-linking agent may assist binding of the cellulose nanofibers. An amount of the cross-linking agent may be in a range of about 1 part to about 50 parts by weight based on 100 parts by weight of the cellulose nanofibers, but embodiments are not limited thereto. Any suitable amount of the cross-linking agent that may improve physical properties of the porous film may be used. For example, an amount of the cross-linking agent may be in a range of about 1 part to about 30 parts, about 1 part to about 20 parts by weight, or about 1 part to about 15 parts by weight, based on 100 parts by weight of the cellulose nanofibers. For example, the cross-linking agent may be at least one selected from isocyanate, polyvinyl alcohol, and polyamide epichlorohydrin (PAE), but embodiments are not limited thereto. Any suitable material available as a cross-linking agent in the art may be used.

The binder may assist binding of the cellulose nanofibers. An amount of the binder may be in a range of about 1 part to about 50 parts by weight based on 100 parts by weight of the cellulose nanofibers, but embodiments are not limited thereto. Any suitable amount of the binder that may improve physical properties of the porous film may be used. For example, an amount of the binder may be in a range of about 1 part to about 30 parts, about 1 part to about 20 parts by weight, or about 1 part to about 15 parts by weight, based on 100 parts by weight of the cellulose nanofibers. For example, the binder may be at least one selected from cellulose single nanofiber, methyl cellulose, hydroxypropyl methylcellulose, hydroxyethyl methyl cellulose, carboxyl methyl cellulose, ethyl cellulose, polyvinylidene fluoride-co-hexafluoropropylene, polyvinylidene fluoride-co-trichloroethylene, polymethylmethacrylate, polyacrylonitrile, polyvinylpyrrolidone, polyvinylacetate, polyethylene-co-vinyl acetate, polyimide, polyethylene oxide, cellulose acetate, cellulose acetate butyrate, cellulose acetate propionate, cyanoethylpullulan, cyanoethylpolyvinylalcohol, cyanoethylcellulose, cyanoethylsucrose, pullulan, and polyvinylalcohol, but embodiments are not limited thereto. Any suitable material available as a binder in the art may be used.

A thickness of the porous film may be 200 μm or less. For example, a thickness of the porous film may be 100 μm or less, 50 μm or less, 40 μm or less, 35 μm or less, 30 μm or less, 25 μm or less, 19 μm or less, 18 μm or less, or 17 μm or less. When the porous film has a high tensile strength while having a reduced thickness within any of these ranges, an energy density and lifespan characteristics of an electrochemical cell including the porous film as a separator may improve at the same time.

According to another embodiment, a separator may include the porous film.

For example, the porous film may be used as a separator. When the porous film is used as a separator, in an electrochemical device including the porous film as a separator, the porous film may allow ion migration between electrodes while blocking electrical contact between the electrodes, thereby improving performances of the electrochemical device.

According to another embodiment, an electrochemical device may include the separator described above. When the electrochemical device includes the separator, the electrochemical device may have improved lifespan characteristics.

The electrochemical device is not particularly limited; any suitable material capable of saving and emitting electricity by an electrochemical reaction in the art may be used. The electrochemical device may be an electrochemical cell or an electric double layer capacitor. The electrochemical device may be a may be an alkali metal battery, e.g., a lithium battery or a sodium battery, or a fuel battery. The electrochemical cell may be a primary battery or a secondary battery that is rechargeable. The lithium battery may be a lithium ion battery, a lithium polymer battery, a lithium sulfur battery, or a lithium air battery.

In some embodiments, the lithium battery may include a positive electrode; a negative electrode, and a separator disposed between the positive electrode and the negative electrode.

The lithium battery may be manufactured as follows.

First, a negative electrode is prepared.

For example, a negative active material, a conductive agent, a binder, and a solvent are mixed to prepare a negative active material composition. In some embodiments, the negative active material composition may be directly coated on a current collector, e.g., a copper foil, to prepare a negative electrode plate. In some embodiments, the negative active material composition may be cast on a separate support to form a negative active material film, which may then be separated from the support and laminated on a copper current collector to prepare a negative electrode plate. The negative electrode is not limited to the examples described above, and may have various other shapes.

In one or more embodiments, the negative active material may be any suitable negative active material for a lithium battery known in the art. For example, the negative active material may include at least one selected from lithium metal, a metal alloyable with lithium, a transition metal oxide, a non-transition metal oxide, and a carbonaceous material.

Examples of the metal alloyable with lithium include silicon (Si), tin (Sn), aluminum (Al), germanium (Ge), lead (Pb), bismuth (Bi), antimony (Sb), a Si—Y alloy (wherein Y is an alkali metal, an alkaline earth metal, a Group 13 element, a Group 14 element, a transition metal, a rare earth element, or a combination thereof, and Y is not Si), and a Sn—Y alloy (wherein Y is an alkali metal, an alkaline earth-metal, a Group 13 element, a Group 14 element, a transition metal, a rare earth element, or a combination thereof, and Y is not Sn). Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), thallium (Tl), germanium (Ge), phosphorus (P), arsenic (As), antimony (Sb), bismuth (Bi), sulfur (S), selenium (Se), tellurium (Te), polonium (Po), or a combination thereof.

Examples of the transition metal oxide include a lithium titanium oxide, a vanadium oxide, and a lithium vanadium oxide.

For example, the non-transition metal oxide may be SnO₂ or SiOₓ (wherein 0<x<2).

Examples of the carbonaceous material may include crystalline carbon, amorphous carbon, and mixtures thereof. Examples of the crystalline carbon may include graphite, such as natural graphite or artificial graphite that are in shapeless, plate, flake, spherical, or fibrous form. Examples of the amorphous carbon may include soft carbon (carbon sintered at low temperatures), hard carbon, meso-phase pitch carbides, and sintered cokes.

The conductive agent may be acetylene black, natural graphite, artificial graphite, carbon black, Ketjen black, carbon fiber, and metal powder and metal fiber of, e.g., copper, nickel, aluminum, or silver. In some embodiments, at least one conductive material such as a polyphenylene derivative may be used alone or in combination, but embodiments are not limited thereto. Any suitable conductive agent known in the art may be used. Any of the above-described crystalline carbonaceous materials may be added as a conductive agent.

Examples of the binder may include a vinylidene fluoride/hexafluoropropylene copolymer, polyvinylidene fluoride (PVDF), polyacrylonitrile, polymethylmethacrylate, polytetrafluoroethylene, and mixtures thereof, and a styrene-butadiene rubber polymer may be further used as a binder, but embodiments are not limited thereto. Any suitable material available as a binder in the art may be further used.

Examples of the solvent include N-methyl-pyrrolidone, acetone, and water, but embodiments are not limited thereto. Any suitable material available as a solvent in the art may be used.

Amounts of the negative active material, the conductive agent, the binder, and the solvent may substantially be the same as those generally used in the art with respect to lithium batteries. At least one of the conductive agent and the solvent may be omitted according to the use and the structure of the lithium battery.

Next, a positive electrode is prepared.

A positive electrode may be manufactured in the same manner as the negative electrode, except that a positive active material is used in place of the negative active material. The same conductive agent, binder, and solvent used to manufacture the negative electrode may also be used to prepare a positive active material composition.

For example, a positive active material, a conductive agent, a binder, and a solvent are mixed to prepare a positive active material composition. In some embodiments, the positive active material composition may be directly coated on an aluminum current collector to prepare a positive electrode plate. In some embodiments, the positive active material composition may be cast on a separate support to form a positive active material film, which may then be separated from the support and laminated on an aluminum current collector to prepare a positive electrode plate. The positive electrode is not limited to the examples described above, and may be one of a variety of types.

The positive active material may further include at least one selected from lithium cobalt oxide, lithium nickel cobalt manganese oxide, lithium nickel cobalt aluminum oxide, lithium iron phosphorous oxide, and lithium manganese oxide, but embodiments are not limited thereto. Any suitable positive active material available in the art may be used.

In some embodiments, the positive active material may be a compound represented by one of LiₐA_{1-b}B_{b}D₂ (wherein 0.90≤a≤1.8 and 0≤b≤0.5); LiₐE_{1-b}B_{b}O_{2-c}D_{c} (wherein 0.90≤a≤1.8, 0≤b≤0.5, and 0≤c≤0.05); LiE_{2-b}B_{b}O_{4-c}D_{c} (wherein 0≤b≤0.5 and 0≤c≤0.05); LiₐNi_{1-b-c}Co_{b}B_{c}D_{α} (wherein 0.90≤a≤1.8, 0≤b≤0.5, 0≤c≤0.05, and 0<α≤2); LiₐNi_{1-b-c}Co_{b}B_{c}O_{2-α}F₆₀ (wherein 0.90≤a≤1.8, 0≤b≤0.5, 0≤c≤0.05, and 0<α<2); LiₐNi_{1-b-c}Co_{b}B_{c}O_{2-α}F₂ (wherein 0.90≤a≤1.8, 0≤b≤0.5, 0≤c≤0.05, and 0<α<2); LiₐNi_{1-b-c}Mn_{b}B_{c}D_{α} (wherein 0.90≤a≤1.8, 0≤b≤0.5, 0≤c≤0.05, and 0<α≤2); LiₐNi_{1-b-c}Mn_{b}B_{c}O_{2-α}F_{α} (wherein 0.90≤a≤1.8, 0≤b≤0.5, 0≤c≤0.05, and 0<α<2); LiₐNi_{1-b-c}Mn_{b}B_{c}O_{2-α}F₂ (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001≤d≤0.1.); LiₐNi_{b}Co_{c}Mn_{d}GeO₂ (wherein 0.90≤a≤1.8, 0≤b≤0.9, 0≤c≤0.5, 0≤d ≤0.5, and 0.001≤e≤0.1.); LiₐNiG_{b}O₂ (wherein 0.90≤a≤1.8 and 0.001≤b≤0.1.); LiₐCoG_{b}O₂ (wherein 0.90≤a≤1.8 and 0.001≤b≤0.1.); LiₐMnG_{b}O₂ (wherein 0.90≤a≤1.8 and 0.001≤b≤0.1.); LiₐMn₂GbO₄ (wherein 0.90≤a≤1.8 and 0.001≤b≤0.1.); QO₂; QS₂; LiQS₂; V₂O₅; LiV₂O₅; LiIO₂; LiNiVO₄; Li_{(3-f)}J₂(PO₄)₃ (wherein 0≤f≤2); Li_{(3-f)}Fe₂(PO₄)₃ (wherein 0≤f≤2); and LiFePO₄.

In the foregoing formulae, A may be selected from nickel (Ni), cobalt (Co), manganese (Mn), and a combination thereof; B may be selected from aluminum (Al), Ni, Co, Mn, chromium (Cr), iron (Fe), magnesium (Mg), strontium (Sr), vanadium (V), a rare-earth element, and a combination thereof; D may be selected from oxygen (O), fluorine (F), sulfur (S), phosphorus (P), and a combination thereof; E may be selected from Co, Mn, and a combination thereof; F may be selected from F, S, P, and a combination thereof; G may be selected from Al, Cr, Mn, Fe, Mg, lanthanum (La), cerium (Ce), Sr, V, and a combination thereof; Q may be selected from titanium (Ti), molybdenum (Mo), Mn, and a combination thereof; I may be selected from Cr, V, Fe, scandium (Sc), yttrium (Y), and a combination thereof; and J may be selected from V, Cr, Mn, Co, Ni, copper (Cu), and a combination thereof.

The compounds listed above as positive active materials may have a surface coating layer (hereinafter, also referred to as “coating layer”). Alternatively, a mixture of a compound without a coating layer and a compound having a coating layer, the compounds being selected from the compounds listed above, may be used. In one or more embodiments, the coating layer may include at least one compound of a coating element selected from oxide, hydroxide, oxyhydroxide, oxycarbonate, and hydroxycarbonate of the coating element. In one or more embodiments, the compounds for the coating layer may be amorphous or crystalline. In one or more embodiments, the coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. In one or more embodiments, the coating layer may be formed using any suitable method that does not adversely affect the physical properties of the positive active material when a compound of the coating element is used. For example, the coating layer may be formed using a spray coating method or a dipping method. The coating method may be well understood by one of ordinary skill in the art, and thus a detailed description thereof will be omitted.

Examples of the positive active material include LiCoO₂, LiCoO₂, LiMnₓO₂ₓ (where, x=1 or 2), LiNi₁₋ₓMnₓO₂ (wherein 0<x<1), LiNi_{1-x-y}CoₓMn_{y}O₂ (wherein 0≤x≤0.5 and 0≤y≤0.5), and LiFePO₄.

Next, a separator may be disposed between the positive electrode and the negative electrode.

Next, an electrolyte is prepared.

For example, the electrolyte may be an organic electrolyte solution. Any suitable electrolyte solution known in the art may be used. Alternately, the electrolyte may be a solid electrolyte. For example, the solid electrolyte may be boron oxide or lithium oxynitride, but embodiments are not limited thereto. Any suitable material available as a solid electrolyte in the art may be used. The solid electrolyte may be formed on the negative electrode by, for example, sputtering, or any method known in the art.

For example, an organic electrolyte solution may be prepared. The organic electrolyte solution may be prepared by dissolving a lithium salt in an organic solvent.

Any suitable solvent known in the art may be used as the organic solvent. For example, the organic solvent may be selected from propylene carbonate, ethylene carbonate, fluoroethylene carbonate, butylene carbonate, dimethylcarbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyl tetrahydrofuran, γ-butyrolactone, dioxolan, 4-methyl dioxolan, N, N-dimethylformamide, dimethylacetamide, dimethylsulfoxide, dioxane, 1,2-dimethoxyethane, sulfolane, dichloroethane, chlorobenzene, nitrobenzene, diethylene glycol, dimethyl ether, and a combination thereof.

The lithium salt may be any suitable material available as a lithium salt in the art. For example, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are each a natural number), LiCl, LiI, or a mixture thereof.

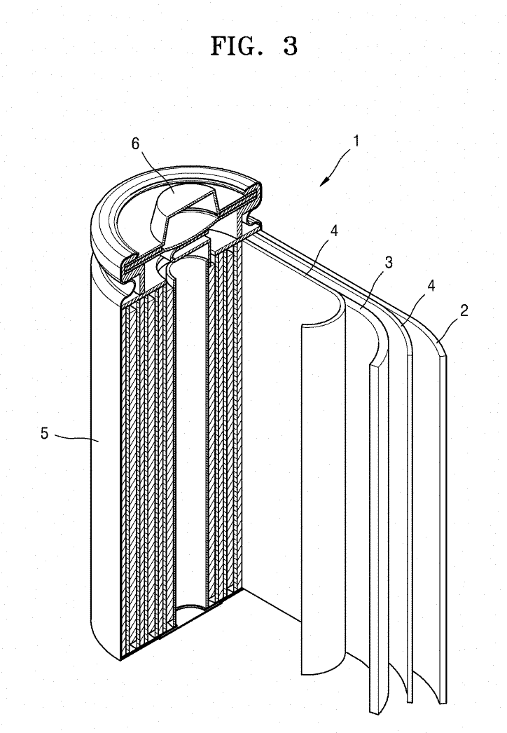

As shown in FIG. 3, a lithium battery 1 includes a positive electrode 3, a negative electrode 2, and a separator 4. The positive electrode 3, the negative electrode 2, and the separator 4 may be wound or folded, and then sealed in a battery case 5. The battery case 5 may be filled with an organic electrolyte solution and sealed with a cap assembly 6, thereby completing the manufacture of the lithium battery 1. The battery case 5 may be a cylindrical type, a rectangular type, or a thin-film type. The lithium battery 1 may be a thin-film-type battery. The lithium battery 1 may be a lithium ion battery.

The separator 4 may be disposed between the positive electrode 3 and the negative electrode 2 to provide a battery assembly. The battery assembly may be stacked in a bi-cell structure and impregnated with the organic electrolyte solution. The resultant assembly may be put into a pouch and hermetically sealed, thereby completing the manufacture of a lithium ion polymer battery.

In one or more embodiments, a plurality of battery assemblies may be stacked to form a battery pack, which may be used in a device that requires large capacity and high power, for example, in a laptop computer, a smartphone, or an electric vehicle.

The lithium battery may have improved lifespan characteristics and high-rate characteristics, and thus may be used in an electric vehicle (EV), for example, in a hybrid vehicle such as a plug-in hybrid electric vehicle (PHEV).

According to another embodiment, a method of forming a porous film includes coating a composition on a substrate; drying the composition to form a sheet on the substrate; and separating the sheet from the substrate to obtain a porous film including the sheet, wherein the composition may include cellulose nanofibers and a hydrophilic pore forming agent that is solid at room temperature. When the hydrophilic pore forming agent is used, a porous film having improved uniformity may be manufactured.

Porous films prepared using a pore forming agent that is liquid at room temperature include a solution including water and the liquid pore forming agent, and a relative composition of the solution may constantly change until water is completely removed from the composition by evaporation, which may result in additional agglomeration or change of arrangement of the liquid pore forming agent drops dispersed within a sheet. Thus, in a case where a porous film is obtained using the pore forming agent that is liquid at room temperature, after the pore forming agent is removed from the sheet using an organic solvent, the porous film may have an irregular pore size and an irregular pore distribution. Further, the pore forming agent may be eluted on a surface of the sheet such that a large area of a liquid film may be formed. Thus, even if the pore forming agent is removed from the sheet by washing, the surface of the porous film may be stained, and the uniformity of the surface of the porous film may deteriorate.

In contrast, in the case where a pore forming agent that is solid at room temperature is used, as water evaporates from the composition, water content decreases such that the pore forming agent may precipitate when a solubility limit of the pore forming agent has been exceeded. Thus, the pore forming agent may be dispersed in a sheet in a solid state, which may suppress additional agglomeration of the pore forming agent precipitate dispersed within the sheet or change of arrangement of the pore forming agent, due to further water evaporation. Thus, in the case where a porous film is obtained using the pore forming agent that is solid at room temperature, after the pore forming agent is removed from the sheet using an organic solvent, the porous film may have improved uniformity of pore size and pore distribution.

In the method of preparing the porous film, an amount of the hydrophilic pore forming agent that is solid at room temperature included in the composition may be in a range of about 1 wt % to about 50 wt %, about 2 wt % to about 40 wt %, about 3 wt % to about 30 wt %, about 4 wt % to about 20 wt %, about 5 wt % to about 15 wt %, about 6 wt % to about 14 wt %, about 7 wt % to about 14 wt %, about 8 wt % to about 12 wt %, about 9 wt % to about 11 wt %, based on the total weight of the composition. When the amount of the hydrophilic pore forming agent is too small, the resulting porous film may have a porosity less than 10%. When the amount of the hydrophilic pore forming agent is excessively large, the resulting porous film may have an excessively increased porosity. Thus, when the resulting porous film is used as a separator in a lithium battery, short circuit may occur in the lithium battery, and thus, the lithium battery may have deteriorated stability.

According to certain embodiments, the method of preparing the porous film may further include washing the porous film or the sheet with an organic solvent in order to remove the remaining pore forming agent from the porous film or the sheet. The method of washing and the number of collecting are not particularly limited, and may be performed one or more times to control physical properties of the porous film. The organic solvent used for washing the porous film or the sheet may be any suitable solvent known in the art that may dissolve the hydrophilic pore forming agent that is solid at room temperature. For example, the organic solvent may be toluene. The porous film can be washed with a solvent to remove the pore forming agent at a temperature above or below the melting temperature of the pore forming agent. Furthermore, the washing step can be performed before or after removing the sheet from the substrate, or both. In the method the substrate may be a glass, PET film, and the like, but embodiments are not limited thereto. Any suitable substrate known in the art may be used.

In the method of preparing the porous film, after removing the hydrophilic pore forming agent that is solid at room temperature by using an organic solvent, the porous film may be dried at a time and temperature that is not particularly limited. For example, the washed porous film may be dried at a temperature ranging from about 20° C. to about 120° C. for 1 minute to 10 hours; however, embodiments are not limited thereto. The drying may be performed, for example, under atmospheric pressure or in a vacuum oven.

In certain embodiments, in the method of preparing the porous film, the hydrophilic pore forming agent that is solid at room temperature may be a monomeric organic compound. For example, the hydrophilic pore forming agent in the composition may include at least one selected from ethylene carbonate, vinylene carbonate, propane sulfone, ethylene sulfate, dimethyl sulfone, ethyl methyl sulfone, dipropyl sulfone, dibutyl sulfone, trimethylene sulfone, tetramethylene sulfone, di(methoxyethyl)sulfone (CH₃OCH₂CH₂)₂SO₂), and ethyl cyclopentyl sulfone (C₂H₅SO₂C₅H₉). The hydrophilic pore forming agent that is solid at room temperature may be understood by referring to the porous film described above.

In certain embodiments of the method of preparing the porous film, the composition applied to the substrate to provide a sheet or film may include water as solvent, but embodiments are not limited thereto. The composition may further include a solvent capable of dissolving the cellulose nanofibers and the hydrophilic pore forming agent that is solid at room temperature.

In the method of preparing the porous film, an amount of the cellulose nanofibers included in the composition may be in a range of about 0.01 wt % to about 50 wt %, about 0.05 wt % to about 40 wt %, about 0.1 wt % to about 30 wt %, about 0.2 wt % to about 20 wt %, about 0.3 wt % to about 15 wt %, about 0.3 wt % to about 10 wt %, about 0.35 wt % to about 8 wt %, about 0.4 wt % to about 6 wt %, or about 0.4 wt % to about 5 wt %, based on the total weight of the composition. When the amount of the cellulose nanofibers is too small, drying may take too much time. Thus, productivity may deteriorate and tensile strength of the porous film may also deteriorate. When the amount of the cellulose nanofibers is too large, excessively increased viscosity may result, and thus, a uniform sheet may not be produced.

In the method of preparing the porous film, the drying temperature, e.g., a temperature for removing water by drying, is not particularly limited; for example, water may be dried at a temperature in a range of about 50° C. to about 120° C. for about 1 minute to about 10 hours. The drying may be performed under atmospheric pressure or in a vacuum oven.

Hereinafter example embodiments will be described in detail with reference to Examples and Comparative Examples. These examples are provided for illustrative purposes only and are not intended to limit the scope of the inventive concept.

(Preparation of Cellulose Nanofiber)

### EXAMPLE 1

(Production of Microbial Cellulose)

In a 1 liter (L) fermentor (GX LiFlus Series Jar-type open system, available from Hanil Science Industrial, a positive pressure was maintained to prevent contamination), wild-type Gluconacetobacter xylinum strain (KCCM 41431) was added to a 700 milliliters (mL) Hestrin-Schramm (HS) medium, to which 1.0 weight/volume percent (w/v %) of carboxymethyl cellulose (CMC (Na-CMC, available from Sigma Aldrich) having a molecular weight was 250,000 Daltons, was added. Incubation was performed by stirring with an impeller at 200 rotations per minute (rpm) at a temperature of 30⊏ for 48 hours. The HS medium included 20 grams per liter (g/L) of glucose, 5 g/L of bacto-peptone, 5 g/L of yeast extract, 2.7 g/L of Na₂HPO₄, and 1.15 g/L of citric acid in water.

A fermented broth, including the resulting carboxyl-group-containing cellulose nanofibers that are uniformly distributed, e.g., paste, was collected. The fermented broth was washed with distilled water three times, and heated in 2% NaOH aqueous solution for 15 minutes at a temperature of 121□ to thereby hydrolyze the cells and impurities present among the carboxyl-group-containing cellulose nanofibers. Subsequently, the resultant was washed with distilled water to obtained purified carboxyl-group-containing cellulose nanofibers. The purified carboxyl-group-containing cellulose nanofibers were mixed with water to prepare a 0.5 wt % carboxyl-group-containing cellulose nanofiber suspension. The prepared suspension was homogenized by using a homogenizer (HG-15A, available from Daehan Science, Korea) to prepare 500 mL of a 0.5 wt % (w/w) homogenized carboxyl-group-containing cellulose nanofiber suspension.

Subsequently, a pressure of 300 bar was applied to the homogenized fermented broth in a microchannel (interaction chamber, size 200 μm) of a nano disperser (ISA-NH500, available from Ilshin Autoclave Co. Ltd, Korea), i.e., a high-pressure homogenizer. Once the application was completed, a high-pressure-homogenized fermented broth containing carboxyl-group-containing cellulose nanofibers was obtained. The high-pressure-homogenized fermented broth containing carboxyl-group-containing cellulose nanofibers was centrifuged to obtain a cellulose precipitate. The precipitate was heated in 2% NaOH aqueous solution for 15 minutes at a temperature of 121□ to thereby hydrolyze the cells and impurities present among the carboxyl-group-containing cellulose nanofibers. Subsequently, the resultant product was washed with distilled water to obtained purified carboxyl-group-containing cellulose nanofibers. The front and rear parts of the microchannel of the high-pressure homogenizer have larger space than the microchannel. Thus, as the fermented broth flows from the narrow microchannel to the large space, the fermented broth is subjected to high velocity decelerating impact by pressure drop and high velocity shearing, thereby being homogenized.

The prepared carboxyl-group-containing cellulose nanofibers had an average diameter of 18 nm, an amount of 0.11 millimole per gram (mmol/g), and a weight-average degree of polymerization of 5,531 DPw.

(Preparation of Porous Film)

### EXAMPLE 2

A pore forming agent, ethylene carbonate (EC, molecular weight (Mw)=88 Daltons, melting point (mp)=37␣, and boiling point (bp)=243␣) was added to 30 mL of a 0.5 wt % of the carboxyl-group-containing cellulose nanofiber dispersion prepared Example 1 diluted with water at an amount of 12.5 wt %. The mixture was stirred at 1,000 rpm at room temperature for 1 hour. The obtained composition was poured onto a petri dish having a diameter of 50 centimeters (cm), and dried at a temperature of 90□ for 2 hours to remove water, thereby obtaining a carboxyl-group-containing cellulose nanofiber film. The carboxyl-group-containing cellulose nanofiber film was impregnated with toluene, and washed four to five times to remove ethylene carbonate, followed by drying, thereby obtaining a porous film at a temperature of 70□ for 1 hour. The porous film is not woven and thus is non-woven fabric.

The porous film was used as a separator.

### COMPARATIVE EXAMPLE 1

A porous film was manufactured in substantially the same manner as in Example 2, except that triethylene glycol (TEG, Mw=150 Daltons, mp=−7□, and bp=285⊐) was used as a pore forming agent instead of ethylene carbonate.

### COMPARATIVE EXAMPLE 2

A porous film was manufactured in substantially the same manner as in Example 2, except that polyehtylene glycol (PEG, Mw=1,000 Daltons) was used as a pore forming agent instead of ethylene carbonate.

### COMPARATIVE EXAMPLE 3

A ceramic coated separator (CCS) (CK1811, available from Toray Co., Ltd., ceramic coated PE separator) was used.

(Manufacture of Lithium Battery)

### EXAMPLE 3

(Preparation of Positive Electrode)

LiNi_{0.6}Co_{0.2}Al_{0.2}O₂ positive active material, a carbonaceous conductive agent (Denka Black), and polyvinylidene fluoride (PVdF) were mixed together at a weight ratio of 94:3:3 to prepare a mixture. The mixture was mixed with N-methyl pyrrolidone (NMP) in an agate mortar to prepare a positive active material slurry. The positive active material slurry was coated to a thickness of about 40 μm on an aluminum current collector having a thickness of 15 μm using a doctor blade. By drying at room temperature and vacuum-drying at a temperature of 120□ and roll-pressing, a positive electrode was prepared including a positive active material layer on the current collector.

(Preparation of Negative Electrode)

Graphite particles having an average particle diameter of 25 μm, styrene-butadiene rubber (SBR) binder (available from Zeon), and CMC (available from Nippon A&L) were mixed together at a weight ratio of 97:1.5:1.5 to prepare a mixture. Subsequently, distilled water was added to the mixture, followed by stirring with a mechanical stirrer for 60 minutes, to thereby prepare a negative active material slurry. The negative active material slurry was coated to a thickness of about 60 μm on a copper current collector having a thickness of 10 μm using a doctor blade. By drying at a temperature of 100□ using a hot-air dryer for 0.5 hours and vacuum-drying at a temperature of 120□ for 4 hours and roll-pressing, a negative electrode plate was prepared.

(Manufacture of Lithium Battery)

The porous film prepared in Example 2 was used as a separator.

In a pouch, the porous film of Example 2 was disposed between the positive electrode and the negative electrode. Subsequently, electrolyte solution was injected thereinto, followed by sealing, to thereby completing the manufacture of a pouch cell.

An electrolyte solution, in which 1.15 M LiPF₆ was dissolved in a mixture solvent including EC:EMC:DMC at a volume ratio of 2:2:6, was used.

### COMPARATIVE EXAMPLE 4

A pouch cell was prepared in substantially the same manner as in Example 3, except that the porous film prepared in Comparative Example 1 was used as a separator instead of the porous film of Example 2.

### COMPARATIVE EXAMPLE 5

A pouch cell was prepared in substantially the same manner as in Example 3, except that the porous film prepared in Comparative Example 2 was used as a separator instead of the porous film of Example 2.

### COMPARATIVE EXAMPLE 6

A pouch cell was prepared in substantially the same manner as in Example 3, except that the porous film prepared in Comparative Example 3 was used as a separator instead of the porous film of Example 2.

### EVALUATION EXAMPLE 1

### Measurement of Presence of Carboxyl Group

An IR spectrum of the cellulose nanofibers prepared in Example 1 was measured to evaluate whether the cellulose nanofibers included carboxyl groups.

The cellulose nanofibers of Example 1 were found to exhibit a peak at around 1,572 cm⁻¹ corresponding to a carboxyl group. Thus, the cellulose nanofibers of Example 1 were found to contain carboxyl groups.

### EVALUATION EXAMPLE 2

### Measurement of Amount of Carboxyl Group

The amount of carboxyl groups in the cellulose nanofiber of Example 1 was measured. The results thereof are shown in Table 1. The amount of carboxyl groups may be measured by an electric conductivity titration method or an ion chromatography method, but accuracy of the results was increased by combining the two methods.

1. Electric Conductivity Titration Method

The amount of the carboxyl group was measured by using electric conductivity titration (or conductometric titration) (Metrohm). 0.05 g of the freeze-dried cellulose nanofibers of Example 1, 27 mL of distilled water, and 3 mL of 0.01 M NaCl were added to a 100 mL-beaker, and a pH of the mixture was adjusted to 3 or lower by using 0.1 M HCl. Subsequently, 0.04 M of NaOH solution was added dropwise to the beaker at 0.2 mL at a time until pH of the mixture reached 10.5, and the amount of carboxyl groups was calculated according to Equation 1 using a curve of conductivity and pH. The results thereof are shown in Table 1.

Amount of carboxyl groups(mmol/g)=[0.04 M×dropwise added NaOH volume (mL)]/0.05 g Equation 1

2. Ion Chromatography

5 mL of 12 mM HCl was added to 0.015 g of the freeze-dried cellulose nanofibers of Example 1, and the mixture was sonicated for 1 hour. After leaving the resultant at room temperature for 15 hours, an amount of Na⁺ was analyzed by ion chromatography, and an amount of carboxyl groups was calculated by using the amount of Na⁺.

Amount of carboxyl groups (mmol/g)=[mmol of Na⁺/0.015 g Equation 2

### EVALUATION EXAMPLE 3

### Measurement of Average Diameter of Cellulose Nanofiber

A diameter of the cellulose nanofibers of Example 1 was obtained by obtaining several images of an appropriately diluted cellulose nanofiber solution using a transmission electron microscope (TEM, Super TEM, available from Titan Cubed), measuring diameters and lengths of 100 the cellulose nanofibers from the images by using an image analyzer, and calculating an average diameter and an average length. Also, a FWHM of the average diameter was calculated from a diameter distribution showing an amount of cellulose according to the diameters of the 100 cellulose nanofibers. The results thereof are shown in Table 1.

### EVALUATION EXAMPLE 4

### Measurement of Weight-Average Degree of Polymerization of Cellulose Nanofiber

A degree of polymerization (DP) of the cellulose nanofibers of Example 1 was calculated by using a degree of polymerization determined by viscosity measurement (DPv) and a weight-average degree of polymerization (DPw).

5 mg of the freeze-dried cellulose nanofibers, 10 mL of pyridine, and 1 mL of phenyl isocyanate were added to a 12 mL-vial, and the contents underwent derivatization at 100° C. for 48 hours. 2 mL of methanol was added to the sample, and the sample was washed with 100 mL of 70% methanol twice and 50 mL of H₂O twice. Then, a molecular weight, molecular weight distribution, and length distribution of the cellulose nanofibers were measured by using gel permeation chromatography (GPC). In the GPC, a Waters 2414 refractive index detector and a Waters Alliance e2695 separation module (available from Milford, Mass., USA) equipped with 3 columns, i.e., Styragel HR2, HR4, and HMW7, were used. Chloroform was used as an eluent at a flow rate of 1.0 mL/min. A concentration of the sample was 1 mg/mL, and an injection volume was 20 microliter (uL). Polystyrene standards (PS, #140) were used as a reference. The results thereof are shown in Table 1.

TABLE 1

| | | | | Weight-average |
|---|---|---|---|---|
| | Amount of | Average | | degree of |
| | carboxyl groups | diameter | FWHM | polymerization |
| | [mmol/g] | [nm] | [nm] | [DPw] |
| Example 1 | 0.11 | 18 | 23 | 5531 |

### EVALUATION EXAMPLE 5

### Measurement of Tensile Characteristics of Porous Film

Regarding the porous films (having an area of 15 mm×50 mm) prepared in Example 2 and Comparative Examples 1 to 3 samples, a tensile modulus and a tensile strength, which is stress at rupture, were measured in a stress-strain curve obtained by stretching the sample at a rate of 5 mm/min using a texture analyzer (TA.XT plus, Stable Micro Systems). Some of the measurement results are shown in Table 2.

### EVALUATION EXAMPLE 6

### Measurement of Thickness, Porosity, and Gurley Value of Porous Film

Regarding the porous films (having an area of 50 mm×50 mm) prepared in Example 2 and Comparative Examples 1 to 3 samples, the thickness, porosity, and Gurley value of porous film (gas permeability) were measured.

The thickness of the porous film sample with a size of 15 mm×50 mm was measured at any 5 points by means of a thickness indicator TM600 (available from Kumagai Riki Kogyo Co., Ltd.).

The porosity of the porous film was measured by calculating according to Equation 3. The porosity was calculated from the weight of the solvent absorbed in the porous film after the porous film was impregnated with the solvent by which the cellulose fibers were not swollen. More particularly, a sample prepared by cutting the porous film into a size of 50 mm×50 mm was moisturized for one day under an atmosphere of 23° C. and 50% relative humidity, and subsequently, a thickness of the sample is measured. In addition, the weight of the sample was also weighed by means of a scale defining a 4-digit or 5-digit number. After weighing the sample, the sample was impregnated with a solvent for one minute. Subsequently, the superfluous solvent present over the surface of the sample was removed with absorbent paper, and the weight of the sample was again weighed. A value obtained by subtracting the weight of the sample before impregnation with the solvent from the weight of the sample after impregnation with the solvent, was divided by the density of the solvent. Thereby, a volume of the solvent was obtained. The obtained value of the solvent volume was divided by the total volume calculated from the thickness, and then multiplied by 100(%). The obtained value defines porosity. The solvent by which the cellulose fibers were not swollen may be a petroleum high boiling point solvent, e.g., kerosene.

The Gurley value, i.e., gas permeability of the porous film was measured by using a permeability tester (Oken Type Air Permeability Tester, EGO-1-55-1MR, available from E-Globaledge) according to JIS P8117. The Gurley value is the time (sec) required for 100 cc of air to pass through a porous film. As gas permeation through the porous film is facilitated, the Gurley value of the porous film may decrease.

Porosity (%)=[(sample weight after absorption-sample weight before absorption)/density of absorbed solvent]×1.5×5×sample thickness×100(%) Equation 3

Some of the measurement results are shown in Table 2.

### EVALUATION EXAMPLE 7

### Measurement of Thermal Shrinkage of Porous Film

The porous film sample of Example 2 (having an area of 50 mm×50 mm) was allowed to be exposed at a temperature of 150□ for 30 minutes. The thickness of the porous film before and after the exposure at a temperature of 150□ to calculate the thermal shrinkage. The thermal shrinkage was calculated according to Equation 4. Some of the measurement results are shown in Table 2. Under the same conditions, a 2320 separator (Celgard™ #2320, a PP/PE/PP triple-filmed separator, available from Asahi Kasei, Japan) had a thermal shrinkage of 20%.

Thermal shrinkage (%)=[(porous film thickness before exposure-porous film thickness after exposure)/porous film thickness before exposure]×100(%) Equatino 4

TABLE 2

| | | | | | Gurley | |
|---|---|---|---|---|---|---|
| | | | | | value | |
| | Tensile | | | Gurley | per μm | Thermal |
| | strength | Thick- | Poros- | value | [sec/ | shrink- |
| | [kgf/ | ness | ity | [sec/ | 100 cc/ | age |
| | cm²] | [μm] | [%] | 100 cc] | μm] | [%] |
| Example 2 | 955 | 16 | 71 | 400 | 25 | <1 |
| Comparative | 776 | 20 | 73 | 365 | 18 | — |
| Example 1 | | | | | | |
| Comparative | 830 | 14 | 62 | 550 | 39 | — |
| Example 2 | | | | | | |
| Comparative | 1000 | 18 | — | 220 | 12 | — |
| Example 3 | | | | | | |
| Reference | — | — | — | — | — | greater |
| Example 1 | | | | | | than |
| | | | | | | 20% |

The tensile strength, tensile modulus, thickness, porosity, Gurley value, contact angle, and thermal shrinkage of the porous films of Example 2 and Comparative Examples 1 to 3 are shown in Table 2. Also, the thermal shrinkage of the separator of Reference Example 1 is shown.

### EVALUATION EXAMPLE 9

### Measurement of Transmittance and Haze of Porous Film

With regard to each of the porous films of Example 2 and Comparative Examples 1 and 2, the transmittance and haze were measured according to ASTM D1003 using a color space CIE1931 (Illuminant C and a 2° observer) at a thickness of 16 μm by using NDH-5000 haze meter (available from Nippon Denshoku Industries Co. Ltd.). The results thereof are shown in Table 3.

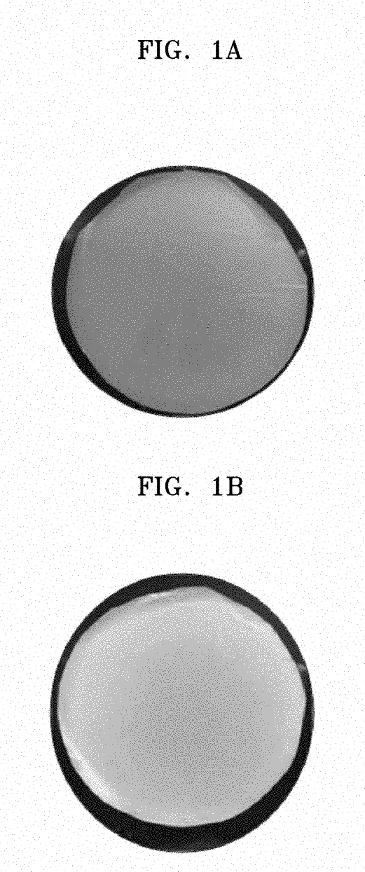

The appearances of the porous films of Example 2 and Comparative Example 1 are respectively shown in FIGS. 1A and 1B. As shown in FIGS. 1A and 1B, it was observed that the porous film of Example 2 has a higher transmittance and a smaller haze than the porous film of Comparative Example 1.

### EVALUATION EXAMPLE 10

### Measurement of Rate in which Porous Films Including Nanofibers Having a Thickness of 200 nm or Greater are Included

With regard to each of the porous films of Example 2 and Comparative Examples 1 and 2, the X-ray diffraction data, obtained by using a X-ray computed tomography analyzer, was set to the threshold level in which a thickness of 200 nm or greater could be observed. The fiber parts were extracted, and a fiber amount was calculated from a rate of the aggregated thick fiber having a thickness of 200 nm or greater, in which several thin fibers were aggregated or tangled, contained in the total amount. The sample was cut into a size of about 1 mm width. The cut sample was fixed by a sample-holding jig, and was subjected to a CT scanning by means of TDM 1000H-Sμ. Measurement of the fiber amount was carried out by extracting any range of 27.89 μm×448.70 μm×432.26 μm at the central part in order to contain no air parts of the outer periphery of the sample. The results thereof are shown in Table 3.

### EVALUATION EXAMPLE 11

### Measurement of Maximal Peak Diameter (Pore Diameter) of Pore Distribution of Porous Film by using a Mercury Penetration Method

With regard to each of the porous films of Example 2 and Comparative Examples 1 and 2, a pore distribution was measured by Autopore IV 9510 model (available from Micromeritics Instrument Corporation) under the conditions of a measuring range of ϕ (pore diameter) 415 to 0.0003 μm, a mercury contact angle of 130 degrees, and a mercury surface tension of 485 dynes/cm. The pore size at the maximal frequency was determined from the obtained pore distribution, and was used as a pore diameter. The results thereof are shown in Table 3.

### EVALUATION EXAMPLE 12

### Measurement of Film Resistance of Porous Film

With regard to each of the porous films of Example 2 and Comparative Examples 1 and 2, a sample holder for solid of SH2-Z model (available from Toyo Corporation) was used as a cell for measuring impedance. A circular porous film formed by punching at a diameter of 19 mm (19 ϕ) was dried for 24 hours or more under the condition of 150⊏. Subsequently, five dried porous films were placed therein in a stacking manner, and then impregnated sufficiently with a 1 mol/L electrolyte solution in which LiPF₆ was dissolved in a mixture solvent including EC:EMC:DMC (at a at a volume ratio of 2:2:6). After the air remaining among porous films was deaerated under reduced pressure down to 0.8 MPa, the porous films were bookended between two faced gold electrodes, and an alternating current impedance (Ω) was measured by using a frequency response analyzer VSP (available from Bio-Logic Science Instrument) in which a potentiostat/galvanostat was combined under the conditions of a swept frequency ranging from 100 millihertz (mHz) to 1 megahertz (MHz) and an amplitude of 10 millivolt (mV). The measurement temperature was 25° C. The measurement results of the film resistance values are shown in Table 3.

### EVALUATION EXAMPLE 13

### Measurement of Amount of Residue in Porous Film

With regard to each of the porous films of Example 2 and Comparative Examples 1 and 2, an amount of remaining impurities (monomeric organic compounds) in the porous film was measured by using gas chromatography-mass spectrometry (GC-MS, 5975C available from Agilent Technologies). The results thereof are shown in Table 3. The amount of remaining impurities was estimated by the weight difference between a non-porous film prepared using the same weight of cellulose nanofibers.

TABLE 3

| | | | Amount of | | | |
|---|---|---|---|---|---|---|
| | | | aggregated | | | |
| | | | nanofibers | | | |
| | | | having a | | | Remain- |
| | Trans- | | thickness | Pore | | ing impu- |
| | mit- | | of 200 nm | diam- | Resis- | rities |
| | tance | Haze | or greater | eter | tance | amount |
| | [%] | [%] | [wt %] | [nm] | [Ω] | [wt %] |
| Example 2 | 90 | 25 | 19 | 70 | 0.5 | 1 |
| Comparative | 81 | 61 | 25 | 125 | 0.5 | 2 |
| Example 1 | | | | | | |
| Comparative | 79 | 78 | 26 | 120 | 0.7 | 4 |
| Example 2 | | | | | | |

In Table 3, the transmittance, haze, amount of nanofibers having a thickness of 200 nm or greater, pore diameter, and volumetric resistance of the porous films of Example 2 and Comparative Examples 1 and 2.

As shown in Table 3, it was found that the porous film of Example 2 has a high transmittance, a low haze, a low amount of nanofibers having a thickness of 200 nm or greater, a small pore diameter, and a low film resistance, as compared with the porous films of Comparative Examples 1 and 2. Thus, the porous film of Example 2 was found to have improved uniformity, as compared with the porous films of Comparative Examples 1 and 2.

### EVALUATION EXAMPLE 14

### Charge/Discharge Characteristics Evaluation

The lithium batteries (pouch cells) prepared in Example 3 and Comparative Examples 4 to 6 were charged with a constant current of a 0.1 C rate at 25° C. until a voltage reached 4.2 V (vs. Li), and charged with a constant voltage while maintaining 4.2 V until a current was 0.01 C. After completing the charging process, the lithium batteries were rested for 10 minutes and then discharged with a constant current of 0.1 C until a voltage of 2.8 V (vs. Li) was reached during a discharge process (1^{st} cycle).

The batteries were then charged with a constant current at a 0.2 C rate until a voltage reached 4.2 V (vs. Li), and charged with a constant voltage while maintaining 4.2 V until a current reached 0.01 C. After completing the charging process, the pouch cells were rested for 10 minutes and then discharged with a constant current of 0.2 C until a voltage reached 2.8 V (vs. Li) during a discharge process (2^{nd} cycle) (1^{st} and 2^{nd} cycles are each a formation process).

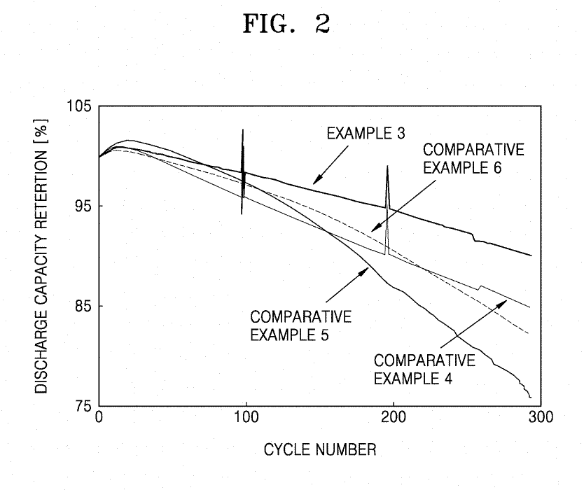

The pouch cells that underwent the formation process were then charged with a constant current at a 1.0 C rate at a temperature of 25□ until a voltage reached 4.2 V (vs. Li), and charged with a constant voltage while maintaining 4.2 V until a current reached 0.01 C. After completing the charging process, the pouch cells were rested for 10 minutes and then discharged with a constant current of 1.0 C until a voltage of 2.8 V (vs. Li) was reached during a discharge process. This cycle was repeated for 300 times. Some of the charge/discharge test results are shown in Table 4 and FIG. 2.

A capacity retention rate was calculated according to Equation 5.

Capacity retention [%]=(discharge capacity at the 300^{th} cycle/discharge capacity at the 1^{st} cycle)×100(%) Equation 5

TABLE 4

| | Capacity retention |
|---|---|
| | [%] |
| Example 3 | 90 |
| Comparative Example 4 | 85 |
| Comparative Example 5 | 76 |
| Comparative Example 6 | 83 |

As shown in Table 4 and FIG. 2, the lithium battery of Example 3, which employs the porous film of Example 2 as a separator, may have improved lifespan characteristics, as compared with the lithium batteries of Comparative Examples 4 to 6, which respectively employ the porous films of Comparative Examples 1 to 3 as a separator. As the separator of Example 2 has improved uniformity, localized failure of the separator may be suppressed, which may consequently result in such effects.

As apparent from the foregoing description, according to one or more embodiments, a porous film including cellulose nanofibers and having a transmittance of 70% or higher and a haze of 50% or lower may have improved uniformity; when a lithium battery employs such a porous film as a separator, the lithium battery may have improved lifespan characteristics.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” folio wed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

What is claimed is:

1. A porous film comprising cellulose nanofibers, wherein the porous film has a light transmittance of 70 percent (%) or higher and a haze of 50% or lower, as measured according to ASTM D1003 using a CIE1931 color space (Illuminant C and a 2° observer) at a thickness of 16 micrometers (μm).

2. The porous film of claim 1, wherein 20% by weight or less of the cellulose nanofibers have a diameter of 200 nanometers (nm) or greater based on a total weight of the cellulose nanofibers.

3. The porous film of claim 1, further comprising a monomeric organic compound that has a melting point of 20° C. or more, wherein the porous film comprises about 10 wt % or less of the monomeric organic compound based on the total weight of the porous film, as measured by using high performance liquid chromatography (HPLC).

4. The porous film of claim 1, wherein the porous film has a Gurley value of about 50 seconds (sec)/100 cubic centimeters (cc) to about 800 sec/100 cc.

5. The porous film of claim 1, wherein a circular sample of the porous film with a diameter of 19 millimeters has an electrical resistance of 0.8 ohm (0) or less when measured using an alternating current of a frequency of 20 kilohertz (kHz) and an electrolyte solution of ethylene carbonate (EC):ethyl methyl carbonate (EMC):dimethyl carbonate (DMC) at a volume ratio of 2:2:6, the electrolyte solution further comprising 1 molar (M) LiPF₆.

6. The porous film of claim 1, wherein the porous film has a porosity as measured by ASTM D-2873 of about 10% to about 90%.

7. The porous film of claim 1, wherein the cellulose nanofibers are carboxyl-group-containing cellulose nanofibers.

8. The porous film of claim 1, wherein the cellulose nanofibers comprise 0.06 millimole per grams (mmol/g) or greater carboxyl groups.

9. The porous film of claim 1, wherein the cellulose nanofibers are microbial cellulose nanofibers.

10. The porous film of claim 1, wherein the porous film has a thermal shrinkage rate of about 5% or less after incubating the porous film at 150□for 30 minutes.

11. A separator comprising the porous film of claim 1.

12. An electrochemical device comprising the separator of claim 11.

13. The electrochemical device of claim 12, wherein the electrochemical device is a lithium battery or an electric double layer capacitor.

14. A method of preparing a porous film, the method comprising:
coating a composition on a substrate, the composition comprising cellulose nanofibers and a hydrophilic pore forming agent that is solid at room temperature;
drying the composition to form a sheet on the substrate; and
separating the sheet from the substrate to obtain a porous film comprising the sheet.

15. The method of claim 14, wherein the hydrophilic pore forming agent is a monomeric organic compound.

16. The method of claim 14, wherein the hydrophilic pore forming agent has a solubility in water of 10 wt % or higher.

17. The method of claim 14, wherein the hydrophilic pore forming agent is a monomeric organic compound having a molecular weight of 500 Daltons or less.

18. The method of claim 14, wherein the hydrophilic pore forming agent has a melting point of 20□ or higher.

19. The method of claim 14, wherein the hydrophilic pore forming agent has a boiling point of 130□or higher.

20. The method of claim 14, wherein the hydrophilic pore forming agent comprises ethylene carbonate, vinylene carbonate, propane sulfone, ethylene sulfate, dimethyl sulfone, ethyl methyl sulfone, dipropyl sulfone, dibutyl sulfone, trimethylene sulfone, tetramethylene sulfone, di(methoxyethyl)sulfone (CH₃OCH₂CH₂)₂SO₂), ethyl cyclopentyl sulfone (C₂H₅SO₂C₅H₉), or a combination thereof.

21. The method of claim 14, wherein the composition coated on the substrate further comprises a cross-linking agent, a binder, or a combination thereof.

22. The method of claim 14, wherein the method comprises washing the sheet before or after separating from the substrate to remove the pore forming agent.
